(19) United States
(12) Patent Application Publication
(10) Pub. No.: US 2026/0150850 A1
(43) Pub. Date: Jun. 4, 2026

(54) MICROBIAL BIOCONTROL PRODUCTS TO PROTECT FLOWERS FROM DISEASE

(71) Applicant: The United States of America, as represented by the Secretary of Agriculture, Washington, DC (US)

(72) Inventor: CAITLIN C. RERING, GAINESVILLE, FL (US)

(21) Appl. No.: 19/394,959

(22) Filed: Nov. 20, 2025

Related U.S. Application Data
(60) Provisional application No. 63/727,721, filed on Dec. 4, 2024.

(51) Int. Cl. A01N 63/32; A01N 63/20; A01P 3/00

(52) U.S. Cl. CPC A01N 63/32; A01N 63/20; A01P 3/00

(57) ABSTRACT

This disclosure provides microbial consortia to target Colletotrichum or Botrytis species that target flowers, such as those of blueberries, to control diseases caused by these phytopathogenic species. Methods of delivery of the consortia to plants, including pre-blossom and post-blossom stages.

### CROSS-REFERENCE

The present application claims priority to U.S. Provisional Patent Application Ser. No. 63/727,721 filed Dec. 4, 2024, the content of which is expressly incorporated herein by reference.

### BACKGROUND OF THE INVENTION

### Field of Invention

This disclosure provides microbial consortia to target Colletotrichum or Botrytis species that target flowers, such as those of blueberries, to control diseases caused by these phytopathogenic species. Methods of delivery of the consortia to plants, including pre-blossom and post-blossom stages.

### Background

The genus Colletotrichum includes many successful opportunistic plant pathogens that cause severe disease in a variety of crops, making it one of the top 10 most economically significant fungal plant pathogens. In blueberry, Colletotrichum species cause the disease anthracnose or ripe rot, so named because although infection usually occurs within flowers, the disease develops without symptoms until fruit begin to ripen. Anthracnose is among the most destructive and economically important diseases of blueberry, impacting most blueberry-producing regions around the world. Left unchecked, anthracnose can lead to 100% post-harvest losses and 10-20% preharvest losses. The fungus overwinters on infected blueberry twigs and buds and is dispersed in the spring primarily via splashing from rain or overhead irrigation. Flowers can become infected by dispersed spores, but infection progresses without apparent symptoms until fruit matures. As fruit ripen, symptoms develop, including sunken or shriveled fruit and vivid orange droplets consisting of spore masses. Taxonomy of this genus is complex and generally organized into species complexes, and several Colletotrichum species cause disease in blueberry. Throughout most of the US and Canada, C. fioriniae (of the C. acutatum species complex) and C. acutatum are the most common species infecting highbush blueberry (Damm et al, Stud. Mycol., (2012), 73:37-113; Waller et al, Phytopathol., (2018), 108:561-7), whereas in Florida, C. gloeosporioides is more prevalent (Smith et al, Plant Dis., (2018), 80:215-8).

Because anthracnose is difficult to detect, blueberry growers rely on preventative, calendar-based fungicide applications to control the disease. Fungicide sprays begin at the bud or early bloom stage and continue to harvest, with 2-3 treatments typically applied every 7-14 days during the bloom. The popular use of fungicides has led to the proliferation of resistant Colletotrichum strains isolated in blueberry and other crops. Additionally, the use of fungicides on blooms in pollinator-dependent crops presents elevated exposure risk to bees. Fungicides are among the most common and abundant agrochemicals detected in flowers, bees, and bee-associated matrices, partly due to their frequent use in blooms. Although fungicides do not generally pose an acute risk to bees, there is growing evidence that chronic exposure to fungicides is a concern. Furthermore, because these chemicals impact the microbiome of flowers by design, they also change the microbial communities associated with nectar and pollen. These changes to reward-associated microbial communities could in turn impact pollinator health. Similarly, fungicide residues in stored honey bee pollen also reduce populations of beneficial fungi, increasing the hive's susceptibility to disease. Developing alternatives to chemical control that reduce fungicide applications to blueberry flowers will reduce pollinators' risk of exposure and toxicity.

Herein, we disclose consortia of nectar microbes to prophylactically inhibit the growth of pathogens that infect flowers. Further disclosed herein are methods of controlling the growth of fungi with the consortia and treating plants with the consortia.

### SUMMARY OF THE INVENTION

Disclosed herein are microbial consortia for controlling a Colletotrichum or Botrytis species, the consortium comprising a carrier, and a combination of bacterial and fungal species as follows:
a. Metschnikowia rancensis, Neokomagataea tanensis, and Neokomagataea thailandica, or;
b. Metschnikowia rancensis, Neokomagataea tanensis, Neokomagataea thailandica, and Symmetrospora symmetrica.

Also disclosed herein are methods of controlling Colletotrichum or Botrytis species, comprising the step of applying one or more of these microbial consortia to a flower in an effective amount to limit growth of the Colletotrichum or Botrytis species. In some embodiments the flower is a blueberry or cranberry flower. In some embodiments, the consortium is delivered to the flower by a pollinator, such as a bee.

### INCORPORATION BY REFERENCE

All publications, patents and patent applications mentioned in this specification are herein incorporated by reference to the same extent as if each individual publication, patent or patent application was specifically and individually indicated to be incorporated by reference.

### BRIEF DESCRIPTION OF THE DRAWINGS

The novel features of the invention are set forth with particularity in the claims. Features and advantages of the present invention are referred to in the following detailed description, and the accompanying drawings of which:

FIG. 1 provides graphical representation of relative growth of Colletotrichum acutatum 18-531 (Cacu1) in artificial nectar inhibition assays. Relative growth was calculated by dividing the number of CFUs in microbial treatments by the mean CFUs in their respective control, such that values<1 signify pathogen growth reduction. Each treatment refers to a single species culture with abbreviations defined herein, ‘Dual’ refers to a mixture of Neokomagataea thailandica and Metschnikowia rancensis, and ‘Trpl’ refers to a three-species culture of N. thailandica, N. tanensis, and M. rancensis. Differences from growth in controls was analyzed using t tests with Bonferroni corrections for multiple comparisons (*** p<0.001, **p<0.01). Significantly different treatments are shaded in white and nonsignificant treatments in grey. Each point represents a sample (n=10 per treatment), and boxplots delineate median, first and third quartiles, and 95% confidence intervals. As a reference, a dotted horizontal line at 1, representing no effect on Cacu1 growth, is provided.

FIG. 2 provides graphical representation of relative growth of pathogens C. acutatum isolates (Cacu1-Cacu4), C. fioriniae (Cfio), and C. gloeosporioides (Cglo) in artificial nectar assays when inoculated to three-species mixture consisting of Neokomagataea thailandica, N. tanensis, and M. rancensis. Relative growth is displayed, such that values<1 signify pathogen growth reduction and values>1 indicate higher growth. A line at 1, representing no effect on pathogen growth, is provided as a reference. Differences from growth in controls was analyzed using t tests with Bonferroni corrections for multiple comparisons (** p<0.01, p<0.1). Each point represents a sample (n=10 per treatment), and boxplots delineate median, first and third quartiles, and 95% confidence intervals.

FIG. 3 provides graphical representation of relative growth of C. acutatum 18-531 (Cacu1) in dual culture assays with various nectar microbes. Species abbreviations are defined in herein and a horizontal line at 1 represents no impact of co-culture on Cacu1 growth. Differences from growth in negative controls was analyzed using t tests with Bonferroni corrections for multiple comparisons (** p<0.01, *** p<0.001). Each point (n=4 per treatment) represents the mean radial growth in a sample normalized by average growth in the negative control. Boxplots delineate median, first and third quartiles, and 95% confidence intervals.

FIG. 4 provides images of C. fioriniae (Cfio) growth in dual culture plate assays against the candidate nectar microbes (from top left) Neokomagataea tanensis (Ntan), Metschnikowia rancensis (Mran), Symmetrospora symmetrica (Symm), Neokomagataea thailandica (Ntha), and in the positive control (0.5 mg cycloheximide), and negative control (PDA media plugs). A plug of C. fioriniae is placed in the center of each plate and two plugs of candidate nectar microbes placed in parallel.

FIG. 5 provides graphical representation of honey bee removal of control and microbial artificial nectar solution in CAFE assay expressed as a percentage of the total nectar consumed per bee (n=12-14 per microbe treatment). No significant differences in consumption of controls and inoculated nectars were identified using t tests with Bonferroni corrections for multiple comparisons. Bars and error bars describe the mean and standard error, respectively.

FIG. 6 provides images of diagnostic symptoms of Colletotrichum infected blueberry fruit.

FIG. 7 provides graphical representation of the proportion of blueberry blooms containing one or more biocontrol consortium species. Replication was as follows: 7 days before spray: 27 flowers; 2 days after spray: 143 flowers; 9 days after spray: 78 flowers. Biocontrol species were identified by morphology.

FIG. 8 provides graphical representation of the number of infected berries collected from flowers enclosed in insect exclusion bags. PTH treatment received pathogen inoculation but were not protected with biocontrol spray. ALL treatment were sprayed with biocontrol microbes and inoculated with the pathogen. MIC treatment received only the biocontrol spray (no pathogen) and CTL were only treated with sterile spray and inoculant. Letters denote statistical differences between groups.

### DETAILED DESCRIPTION OF THE INVENTION

Microbial biocontrol, where microorganisms or their metabolites are used to manage plant diseases or pests, offers an attractive alternative to chemical control because it is generally lower cost and provides greater safety to farm workers, consumers, and non-target species. Furthermore, biocontrol products also have a very low risk of resistance development. Whereas many fungicides use a single mode of action, most microbial biocontrol products have several mechanisms that can confer biocontrol activity, such as competition for resources or space, direct microbe-microbe antibiosis (e.g., hyperparasitism, production of antimicrobial metabolites), and the induction or priming of plant defenses.

Despite these advantages, several challenges have limited the adoption of microbial biocontrol on a broader scale, such as poor microbial survival in, or colonization of, the phyllosphere or rhizosphere, reduced in situ activity relative to observations from in vitro tests, and a relatively milder efficacy to a narrower range of target pathogens than is typical in chemical control (Pirttilä et al, Microorganisms, (2021), 9:817). In addition to the general challenges associated with biocontrol mentioned previously, floral biocontrol, especially that of pollinator-dependent crops like blueberry, is preferably compatible with the needs of pollinators. Such biocontrol measures also preferably preserve adequate nutrition in pollen (lipids, proteins, vitamins) and nectar (carbohydrates) and foster adequate palatability to pollinators. Floral biocontrol agents, consortia or measures preferably also do not interfere with crop fertilization or yields and are safe and attractive for consumers.

We sought to identify microorganisms isolated from blueberry flowers and determine if they could inhibit the growth of Colletotrichum, an opportunistic plant pathogen that infects flowers and threatens yields, and to assess the impacts of floral microbes and Colletotrichum pathogens on artificial nectar sugars and honey bee consumption. The growth inhibition of Colletotrichum (C. acutatum, C. fioriniae, C. gloeosporioides) was screened using both artificial nectar co-culture and dual culture plate assays. The top candidate nectar microbes showing strongest inhibition of C. acutatum (Neokomagataea thailandica, N. tanensis, Metschnikowia rancensis, and Symmetrospora symmetrica) were evaluated for antagonism against three additional C. acutatum isolates, and single isolates of both C. fioriniae and C. gloeosporioides. Neither honey bee consumption of nectar nor nectar sugar concentrations were affected by any microbe or pathogen tested. The results reported here show that the consortia described herein can provide prophylactic protection against fungal pathogens, suggesting they could be developed as a sustainable, pollinator-safe microbial biocontrol product for blooms, including blueberries and cranberries.

Preferred embodiments of the present invention are shown and described herein. It will be obvious to those skilled in the art that such embodiments are provided by way of example only. Numerous variations, changes, and substitutions will occur to those skilled in the art without departing from the invention. Various alternatives to the embodiments of the invention described herein may be employed in practicing the invention. It is intended that the included claims define the scope of the invention and that methods and structures within the scope of these claims and their equivalents are covered thereby.

Technical and scientific terms used herein have the meanings commonly understood by one of ordinary skill in the art to which the instant invention pertains, unless otherwise defined. Reference is made herein to various materials and methodologies known to those of skill in the art.

Any suitable materials and/or methods known to those of skill can be utilized in carrying out the instant invention. Materials and/or methods for practicing the instant invention are described. Materials, reagents and the like to which reference is made in the following description and examples are obtainable from commercial sources, unless otherwise noted. This invention teaches methods and describes tools for treating flowers and other plant surfaces for prophylactic protection from, and treatment of fungal phytopathogens, including Colletotrichum and Botrytis species using microbial consortia.

As used in the specification and claims, use of the singular “a”, “an”, and “the” include plural references unless the context clearly dictates otherwise.

The terms isolated, purified, or biologically pure as used herein, refer to material that is substantially or essentially free from components that normally accompany the referenced material in its native state.

The term “about” is defined as plus or minus ten percent of a recited value. For example, about 1.0 g means 0.9 g to 1.1 g and all values within that range, whether specifically stated or not.

The term “a nucleic acid consisting essentially of”, and grammatical variations thereof, means nucleic acids that differ from a reference nucleic acid sequence by 20 or fewer nucleic acid residues and also perform the function of the reference nucleic acid sequence. Such variants include sequences which are shorter or longer than the reference nucleic acid sequence, have different residues at particular positions, or a combination thereof.

The term “antifungal activity”, and grammatical variations thereof, refers to the ability of a composition of the present invention to impede growth of a fungus, or kill a fungal cell, when present in an effective amount. “Antifungal” refers specifically to the capability of a composition to impede growth of, or kill, fungi (e.g., Colletotrichum sp.), when present in an effective amount. All of these terms include organisms that exhibit both microscopic and macroscopic growth.

“Carrier” as used herein refers to any method of dispersal, dispensation, application, timed-release, encapsulation, microencapsulation, or the like to apply the insect repellant composition as further described herein. In embodiments, such “carriers” may include a variety of microencapsulation, controlled release, and other dispersion technologies available to those of ordinary skill in the art.

The term “controlling fungal growth” and grammatical variants thereof, denotes any activity for inhibiting or at reducing the growth of target fungi (such as Colletotrichum sp.) in a given environment. The term “inhibiting”, as used herein, is to be understood as not only to include the prevention of further growth of but also to killing of any given fungus. The term “reducing”, as used herein, denotes any decrease in a fungus' growth (or growth rate), for example, a decrease of at least 5%, 10%, 15%, 20%, 25%, 30%, 40%, 50%, 60%, 70%, 80%, 85%, 90% or 95% as compared to control conditions (i.e. in the absence of antimicrobial agents according to the present invention).

The term “effective amount” of a microbial consortium composition provided herein refers to the amount of the composition capable of performing the specified function for which an effective amount is expressed. The exact amount required can vary from composition to composition and from function to function, depending on recognized variables such as the compositions and processes involved. An effective amount can be delivered in one or more applications. Thus, it is not possible to specify an exact amount, however, an appropriate “effective amount” can be determined by the skilled artisan via routine experimentation.

The term “plant” includes whole plants, plant organs, progeny of whole plants or plant organs, embryos, somatic embryos, embryo-like structures, protocorms, protocorm-like bodies (PLBs), and suspensions of plant cells. Plant organs comprise, e.g., shoot vegetative organs/structures (e.g., leaves, stems and tubers), roots, flowers and floral organs/structures (e.g., bracts, sepals, petals, stamens, carpels, anthers and ovules), seeds (including embryo, endosperm, and seed coat) and fruit (the mature ovary), plant tissue (e.g., vascular tissue, ground tissue, and the like) and cells (e.g., guard cells, egg cells, trichomes and the like).

The embodiments illustratively disclosed herein suitably may be practiced in the absence of any element [e.g., method (or process) steps or composition components)] which is not specifically disclosed herein. Thus, the specification includes disclosure by silence. Written support for a negative limitation may also be found through the absence of the excluded element in the specification, known as disclosure by silence.

Having generally described this invention, the same will be better understood by reference to certain specific examples, which are included herein to further illustrate the invention and are not intended to limit the scope of the invention as defined by the claims.

### EXAMPLES

### Example 1

### Microbial Species.

Candidate microbes evaluated for antagonism potential were isolated from highbush blueberry (Vaccinium corymbosum) and shiny blueberry (Vaccinium myrsinites) plants located on farms and nature preserves in North and Central Florida (Rering et al, FEMS Microbiol. Ecol., (2024), 100:fiae020). We selected microbes that were frequently observed and achieved high cell densities according to colony-forming unit (CFU) enumeration, or species that were less common but had previously been described at the species or genus level to antagonize plant pathogen growth, totaling 5 yeasts and 9 bacteria (Table 1). Biocontrol candidates and pathogens were cultivated from glycerol stocks (30% glycerol, 60 g L⁻¹ fructose, 60 g L⁻¹ glucose, 30 g L⁻¹ sucrose, 0.1 mM amino acids: L-glycine, L-alanine, L-asparagine, L-aspartic acid, L-glutamic acid, L-proline, L-serine) held at −80° C. Candidate species were propagated on YMA media (Difco, Sparks, Maryland) for yeasts and either TSA media (Criterion, Santa Maria, California) for Acinetobacter apis and A. nectaris or 16% sucrose R2A media (Oxoid, Hampshire, England) for all other bacteria. Fungal pathogens (Table 2; Colletotrichum acutatum, C. fioriniae, C. gloeosporioides) were cultivated on PDA media (Oxoid). Cells were subcultured to fresh media no more than four times before being re-propagated from stocks. Plate media was supplemented with antibiotics to select for bacteria or fungal growth, either cycloheximide or chloramphenicol, respectively (100 mg L⁻¹). Depending on their growth rate, strains and pathogens were incubated for 1-10 days at 22-23° C. on the bench until growth plateaued.

TABLE 1
Biocontrol candidate species isolated from 181 blueberry
nectar samples and their detection frequency in
a culture-dependent survey of floral nectar.

| | | | GenBank | Detection |
|---|---|---|---|---|
| | | | Accession | frequency |
| Kingdom | Species | Abbr. | no. | (%) |
| Fungi | Sporidiobolus pararoseus | Spar | OP205146 | 2.8 |
| | Metschnikowia peoriensis | Mpeo | OP205149 | <1 |
| | Metschnikowia rancensis | Mran | OP205142 | 12.2 |
| | Metschnikowia reukaufii | Mreu | OP205145 | 9.9 |
| | Symmetrospora | Symm | OP205153 | 19.3 |
| | symmetrica | | | |
| Bacteria | Acinetobacter apis | Aapi | OP595655 | 9.9 |
| | Acinetobacter nectaris | Anec | OP595657 | 6.1 |
| | Bacillus velezensis | Bvel | OP595678 | 16.6 |
| | Gluconobacter | Gwan | OP595683 | 7.2 |
| | wancherniae | | | |
| | Kocuria rhizophila | Krhi | OP595656 | 7.7 |
| | Neokomagataea tanensis | Ntan | OP595675 | 11.0 |
| | Neokomagataea | Ntha | OP595638 | 24.9 |
| | thailandica | | | |
| | Pantoea agglomerans | Pagg | OP595661 | 15.5 |
| | Rosenbergiella sp. | Rose | OP595646 | 28.2 |

TABLE 2
Colletotrichum isolates used in antagonism tests.

| | | | | GenBank | |
|---|---|---|---|---|---|
| | | | Isolate | Accession | |
| Species | Abbr. | Source | no. | no. (ITS) | Reference |
| C. acutatum | Cacu1 | blueberry | 18-531 | — | — |
| C. acutatum | Cacu2 | blueberry | 18-551 | — | — |
| C. acutatum | Cacu3 | blueberry | 05-218 | MK130734 | Xavier et al, Plant Dis., |
| | | | | | (2019), 103: 2771-80 |
| C. acutatum | Cacu4 | blueberry | 05-88 | EU647299 | Mackenzie et al, |
| | | | | | Phytopath., (2009), |
| | | | | | 99: 620-31 |
| C. fioriniae | Cfio | apple | ACFK-25 | MN684839 | Khodadadi et al, Sci. |
| | | | | | Rep., (2020), |
| | | | | | 10: 11043 |
| C. gloeosporioides | Cglo | blueberry | 19-220 | — | — |

### Analysis of Blueberry Nectar Amino Acids.

To inform the composition of the artificial blueberry nectar used in inhibition assays and honey bee preference assays, we collected nectar from 18 highbush blueberry (Vaccinium corymbosum cv. Sunshine) plants. Plants were grown in 3-gallon pots in a commercial potting soil amended with a granule fertilizer applied per manufacturer recommendations (OSMOCOTE Plus 15-9-12) and occasionally fertilized with liquid feed (Peter's Professional 20-20-20) during the growing season. In mid-December 2021, the plants were moved into a greenhouse before flowering. To exclude floral visitors, thereby preserving nectar for collection and limiting the introduction of microbes to nectar, we placed plants in a clean room free of flying insects on tables. Each table leg was placed in a large bowl of water to prevent crawling insects from visiting flowers. Nectar from the plants was occasionally plated to selective YMA and R2A media to evaluate microbial contamination, however colonies were never observed.

Nectar sampling occurred over the course of the bloom period in Spring 2022. Nectar was extracted with 20 μL autopipettes and pooled across flowers and plants until 3 replicates of approximately 100 μL each were collected. Pooled samples were stored at −20° C. and then analyzed for a total of 22 amino acids. Two methods liquid chromatography (LC) methods were used, online derivatization with LC-diode array detection and LC-triple quadrupole mass spectrometry, generally following the protocols described in Rering et al, Environ. Microbiol., (2021), 23:141-50.

### Artificial Nectar Inhibition Assays.

To evaluate the ability of an established single species culture to suppress the growth of a later-arriving pathogen, we conducted inhibition assays in artificial nectar over 48 h. For each candidate species, 10 samples containing candidate species and pathogens and 10 negative controls that only received pathogens (100 μL each) were prepared in filter sterilized (0.22 μm, EZFLOW; Salem, New Hampshire) artificial nectar (130 g L⁻¹ each fructose and glucose, 70.5 mg L⁻¹ or 0.55 mM amino acids, Table 3: Blueberry nectar concentrations are reported as mean (standard error) for 3 replicates) in 2 mL centrifuge tubes (FISHERBRAND; Waltham, Massachusetts). Nectar sugar concentrations were representative of blueberry nectar (Rering et al, FEMS Microbiol. Ecol., (2024), 100:fiae020). Candidate species were prepared at initial concentrations of 10⁴ cells μL⁻¹ for all bacteria and the yeast Symmetrospora symmetrica and 10³ cells μL⁻¹ for all other yeasts. These concentrations were selected as representative of mean microbial cell densities of yeast and bacteria in blueberry nectar as determined via plating and CFU enumeration (966 and 5,952 cells μL⁻¹, for bacteria and yeast, respectively; Rering et al, FEMS Microbiol. Ecol., (2024), 100:fiae020). We selected a higher initial concentration for S. symmetrica because this yeast was very abundant in blueberry nectar, reaching the highest cell density of any fungi (average approximately 2,000 cells μL⁻¹, maximum 39,700 cells μL⁻¹; Rering et al, FEMS Microbiol. Ecol., (2024), 100:fiae020). Sterile controls containing no biocontrol candidates or pathogens (n=3 per pathogen and candidate experiment) were prepared and analyzed in parallel.

TABLE 3
Amino acids in blueberry nectar samples and artificial nectar.

Concentration (mg L⁻¹)

| | Blueberry | | Artificial |
|---|---|---|---|
| Amino acid | nectar | | nectar |
| AABA (α-aminobutryic acid) | 20.6 | (10.7) | 17.8 |
| Alanine | 0 | | 0 |
| Arginine | 8.30 | (7.4) | 5.26 |
| Asparagine | 3.95 | (1.13) | 3.47 |
| Aspartic acid | 0.067 | (0.030) | 0.067 |
| GABA (γ-aminobutyric acid) | 1.05 | (0.37) | 0.92 |
| Glutamic acid | 0 | | 0 |
| Glutamine | 15.1 | (3.22) | 13.4 |
| Glycine | 0 | | 0 |
| Histidine | 0.957 | (0.538) | 0.68 |
| Homoserine | 0.301 | (0.104) | 0.29 |
| Hydroxyproline | 0.365 | (0.071) | 0.35 |
| Isoleucine | 0.018 | (0.014) | 0.067 |
| Leucine | 1.07 | (0.879) | 0.71 |
| Lysine | 14.9 | (3.14) | 14 |
| Methionine | 0.047 | (0.045) | 0.038 |
| Ornithine | 0.487 | (0.059) | 0.3 |
| Phenylalanine | 0.194 | (0.026) | 0.2 |
| Proline | 1.79 | (0.36) | 1.8 |
| Serine | 0.937 | (0.389) | 0.85 |
| Taurine | 4.68 | (4.68) | 10.5 |
| Tryptophan | 0.103 | (0.028 | 0.09 |

| | | |
|---|---|---|
| Total | 74.9 | 70.5 |

Samples were incubated upright on an orbital shaker operating at 150 rpm. Because temperature can impact nectar microbe growth rates, competition, and survival in communities, we used a temperature program designed to mimic weather conditions coinciding with blueberry bloom in Central Florida during early February (12.4-21.5° C.). Initial temperatures in the incubator corresponded to field conditions occurring between 8-10 AM. After 24 h, we inoculated a pathogen to samples and controls (10 μL at 11,000 cells μL⁻¹, final concentration 10³ cells μL⁻¹). At 48 h, pathogen cell density was quantified by CFU enumeration according to their morphology. Samples and controls were diluted in sterile water (1:10-1:10²) and 10 μL was plated to selective PDA media. We conducted CFU counts 3-5 days after plating according to growth rates and CFU density. CFUs of samples and their corresponding negative controls (pathogen only) were always scored at the same time. Inhibition was evaluated by comparing pathogen cell density in negative controls vs. samples.

To prepare samples at the specified cell densities, concentrated microbial stock solutions were made by adding 1-2 mL artificial nectar to a plate, liberating the cells from the plate surface with an inoculation loop, and pipetting the cell-laden nectar to a vial. Except for Symmetrospora symmetrica, all yeast and fungi were quantified by microscopy with a hemocytometer. Bacteria and S. symmetrica stocks were quantified via spectrophotometry and adjusted to 0.2 A at 600 nm. This stock concentration is equivalent to approximately 5×10⁵ cells μL⁻¹ according to preliminary tests with Rosenbergiella spp. absorbance readings and CFU counts.

First, all candidate species were screened individually for their capacity to inhibit the growth of Colletotrichum acutatum 18-531 (Cacu1). After Cacu1 inhibition was detected in three candidate species, we additionally evaluated the capacity of candidate consortia (2-3 species) to inhibit Cacu1 growth. We further examined the capacity of the three-species consortium to inhibit the growth of other C. acutatum isolates (Cacu2-Cacu4), C. fioriniae and C. gloeosporioides.

### Dual Culture Plate Inhibition Assays.

To model inhibition of the microbes on floral tissues apart from nectar, we performed a dual culture plate inhibition assay. For each replicate, a pathogen plug (5 mm diameter) was placed in the center of an 85 mm PDA plate containing no antibiotics. Two plugs (5 mm diameter) from a single potential biocontrol species were then placed in parallel 28 mm from the pathogen. To avoid inhibition of Colletotrichum from cycloheximide in R2A media, bacteria propagated for this assay were cultivated on media that did not contain antibiotics. Negative controls, where PDA plugs without microbes were placed alongside the pathogen, and positive controls, where 0.5 mg cycloheximide dissolved in 5 μL methanol was spiked to the plate on either side of the pathogen plug, were performed alongside all treatments. Four replicates were prepared for each treatment and control. Plates were incubated on the benchtop at 22-23° C. After 4-5 days, the radial growth from the outer edge to the center of the pathogen plug were measured for each side. The two measurements were averaged and recorded. To identify inhibition of pathogens, the mean radial growth was compared between the treatments and negative controls.

As with the nectar inhibition assays, we initially screened all candidate microbes for their capacity to inhibit the growth of Cacu1. After identifying four promising species, we further investigated their inhibition of other pathogens, including the other C. acutatum strains (Cacu2-4), C. fioriniae, and C. gloeosporioides.

Two-Choice Honey Bee Preference Assays with Artificial Nectar.

To assess honey bee acceptance of nectar microbes and pathogens, we performed a modified café assay as described in Reade et al. (J. Apic. Res., (2016), 55:53-5 and Crowley-Gall et al., Plant Dis., (2022), 106:32-8). Free-flying honey bees were collected from five hives in an apiary located in Gainesville, FL. Experiments were conducted from 3 May-29 Jul. 2023. This study was conducted under the supervision of researchers of the United States Department of Agriculture Agricultural Research Service, Gainesville FL, USA. Hives were maintained according to standard practices. No permits were required to conduct the study.

At the start of each trial, individual bees were immediately placed in the assay containers (height 9 cm, diameter 6.4 cm) with the lid down and modeling clay applied to support and stabilize. Wire mesh was installed at the base of containers for ventilation, and two holes (1.5 mm) were drilled 5 mm from the outer perimeter of the lid to allow the insertion of two 100 μL microcapillary tubes (Drummond Scientific; Broomall, Pennsylvania). Microcapillary tubes were filled with approximately 100 μL artificial nectar containing either sterile nectar or microbe-inoculated nectar. Control and treatment microcapillary placement were randomized between trials. At the beginning and end of the trial, the nectar volume was marked on the microcapillary tubes to allow measurement of the nectar volume removed. Bees were allowed to forage for 2 h in an incubator held at approximately 26° C. and 41% RH under constant light, after which the volume of nectar removed from each microcapillary tube was recorded. Three evaporative controls without bees were conducted in parallel for each trial. After the 2 h feeding period, bees were marked with non-toxic paint to ensure individuals were not re-used in future experiments and returned to the apiary. Honey bees that died or did not feed (nectar removed during assay not different from evaporative controls) were removed from the dataset. For each treatment, 12-14 bees were tested.

Artificial nectar used in honey bee foraging experiments was inoculated 48 h prior to use in the bee foraging assay according to the procedure described above for artificial nectar inhibition assays, except 200 μL was prepared in each vial. Yeast (except S. symmetrica) and pathogens were added to artificial nectar at a final concentration of 10³ cells μL⁻¹ and bacteria and S. symmetrica at 10⁴ cells μL⁻¹, again corresponding to naturally occurring microbial cell densities in blueberry nectar. Samples and sterile controls (n=14 each treatment) were incubated shaking at 150 rpm under the temperature program described previously. After 48 h, nectar was collected in the modified microcapillary tubes described above. Two aliquots of nectar were reserved from samples for additional analyses. First, to check for microbial growth, 10 μL was plated from four randomly selected samples. Second, an additional 5 μL aliquot was reserved for sugar analysis (see below).

### Artificial Nectar Sugar Analysis.

Prior to the initiation of honey bee foraging assays, an artificial nectar aliquot (5 μL) was collected from 4 samples and 2 sterile controls for each microbial treatment. This aliquot was diluted with water to a final volume of 1 mL, filter-sterilized, and stored at −20° C. Thawed artificial nectar was then analyzed by liquid chromatography with refractive index detection (LC-RID, Agilent Technologies, Santa Clara, CA). Samples were injected (10 μL) with a 3 s needle wash and sugars separated on a Zorbax carbohydrate analysis column (Agilent Technologies, 4.6×150 mm, 5 μm) held at 35° C. with 75:25 acetonitrile/water at a flow rate of 0.9 mL min⁻¹. The RID was auto zeroed before each injection and operated in positive polarity at 35° C. at a scan rate of 2.28 Hz. Data was collected with a 5% zero offset and 5×10⁵ nRIU attenuation. Fructose and glucose were quantified using external calibration standards (75-750 mg L⁻¹). Statistical analyses.

Analyses were performed using R Statistical Software (v4.2.2; R Core Team 2022). We performed a series of two-tailed t tests with p values corrected for multiple comparisons using the Bonferroni method via the functions t.test and p.adjust in the stats package. To evaluate whether candidate microbes inhibited pathogen growth in the artificial nectar assays, t tests were used to compare pathogen growth (CFU) in controls and microbial cultures. To assess growth inhibition in the dual culture plate assays, pathogen growth, measured as the distance from outer edge of the pathogen's mycelial growth to the center of the plug, was compared between the control and the microbe test with t tests.

Additionally, to compare the performance of Ntha, Ntan, Mran, and mixtures of these microbes in artificial nectar co-cultures (Dual and Trpl, see Results), we normalized Cacu1 growth between treatments to control for potential differences in pathogen viability between weeks. To calculate relative pathogen growth, we divided CFUs in co-cultures by the average CFUs in respective controls. We then compared the relative growth of single species and mixtures with a one-way analysis of variance model (aov function in the stats package). Model fit was evaluated with the function check_model in the easystats package (easystats.github.io/easystats/).

To evaluate honey bee feeding preference for microbial solutions in the two choice assays, we performed paired t tests comparing removal of sterile and inoculated artificial nectars. To explore the effects of microbes on artificial nectar sugars, we log-transformed nectar concentrations and used linear models with response variables of fructose, glucose, and total sugars (sum of fructose and glucose) and fixed effect of microbial species with a random effect of experiment. Models were fit using the lme4 (Bates et al, J. Stat. Softw., (2015), 67:1-48) and lmerTest (Kuznetsova et al., J. Stat. Softw., (2017), 82:1-26) packages and model performance was evaluated by examining residuals using the check_model function in the easystats package. Statistical significance for linear model factors was evaluated using analysis of variance with the anova function.

### Results and Discussion

Twenty-two amino acids were screened in nectar and 19 were detected. Total concentrations averaged approximately 75 mg L⁻¹ or 0.58 mM. Notably, the three amino acids that were not detected, alanine, glutamic acid, and glycine, were measured via LC-DAD, a less sensitive method (limit of detection approximately 0.5 mg L⁻¹), so it is possible that low levels of these amino acids were present in floral nectar but remained undetected with our methods.

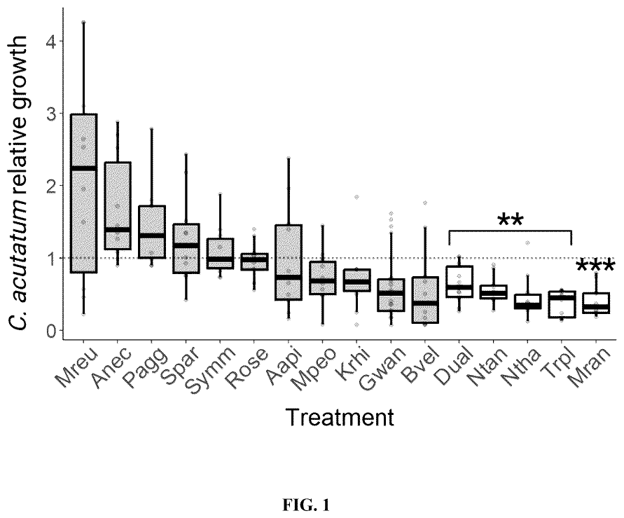

All selected microorganisms and pathogens survived in the artificial nectar tests throughout the incubation period. Three candidate species, Neokomagataea thailandica, N. tanensis, and the yeast Metschnikowia rancensis inhibited the growth of Colletotrichum acutatum 18-531 (Cacu1) in artificial nectar tests (FIG. 1). Average growth inhibition in these species ranged from 43-60% reduction in CFUs in sample co-cultures vs. pathogen only controls. Similar Cacu1 inhibition was detected with a three-species mixture consisting of both Neokomagataea spp. and M. rancensis (‘Trpl’ in FIG. 1; 64% inhibition) and with a two-species mixture consisting of N. thailandica and M. rancensis (‘Dual’ in FIG. 1; ca. 35% fewer CFU). We compared relative Cacu1 growth among the biocontrol treatments that limited growth relative to their respective controls (Mran, Ntha, Ntan, Dual, and Trpl), and found a weak signal for differences between biocontrol candidate solutions (p=0.098). Post hoc Tukey honestly significant difference test did not detect differences between Cacu1 growth between the various effective biocontrol solutions (p≥0.12).

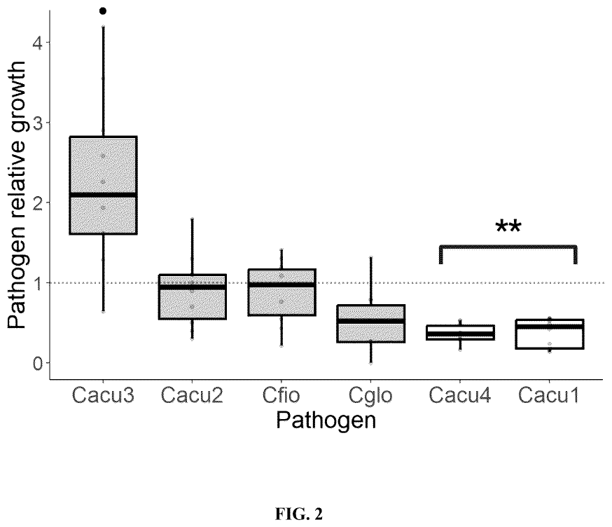

Given the inhibition of Cacu1 when inoculated to the three-species mixture described above, we further explored inhibition of this mixture toward other C. acutatum strains (Cacu2-4), and strains of C. gloeosporioides, and C. fioriniae (FIG. 2). Among the C. acutatum strains, a similar reduction in growth was identified between the originally tested Cacu1 and Cacu4 (63% Cacu4 growth reduction, p=0.008). However, the three-species mixture did not affect Cacu2 growth (p=1) and a weak signal for increased growth was detected for Cacu3 (p=0.09). Growth of C. fioriniae (p=1) or C. gloeosporioides (p=0.25) was also not inhibited with the three-species co-culture.

### Growth Inhibition in Dual Culture Plate Assays

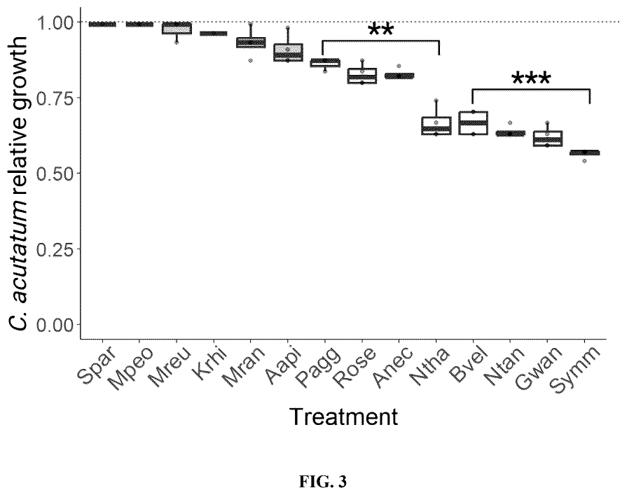

Of the 14 candidate strains evaluated, eight inhibited the growth of Cacu1 in the dual culture plate assays (FIG. 3). Growth inhibition ranged from 14-44%. The strongest signals for inhibition were observed for Symmetrospora symmetrica, Gluconobacter wancherniae, Neokomagataea tanensis, and Bacillus velezensis (p<0.001). N. thailandica, Acinetobacter nectaris, Rosenbergiella spp., and Pantoea agglomerans also inhibited growth (p<0.01). Positive controls prepared with cycloheximide also showed reduced or no growth for all pathogens (data not shown).

Given these results, four species were selected for further testing against additional Colletotrichum isolates. Nectar bacteria N. thailandica and N. tanensis were selected because they inhibited growth in both in vitro assays, and M. rancensis and S. symmetrica were selected because they reduced growth in one, but not both assays: M. rancensis only reduced growth in the artificial nectar assay, and S. symmetrica only in the dual culture plate assay.

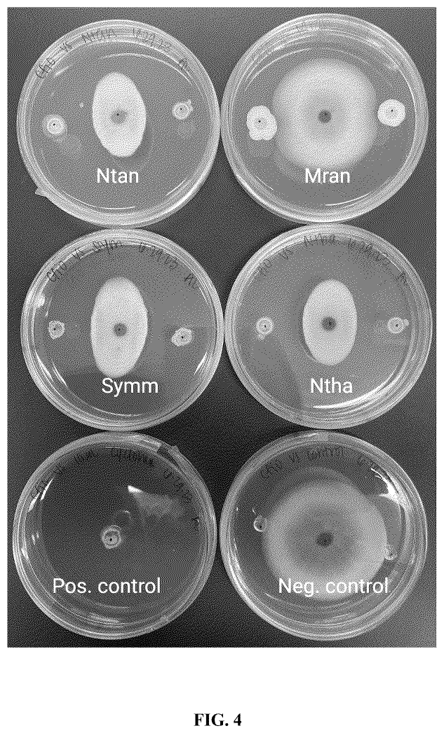

A similar pattern of inhibition was observed for the C. acutatum and C. gloeosporioides strains (Table 4: Values<1 indicate growth inhibition and are bolded when p<0.05. Differences from growth in negative controls was analyzed using t tests with Bonferroni corrections for multiple comparisons (• p<0.1, * p<0.05, ** p<0.01, *** p<0.001). Species abbreviations are defined in Tables 1 and 2) as was observed with Cacu1. In all pathogens, S. symmetrica and both Neokomagataea species inhibited radial growth pathogen growth by about 50-60%, but M. rancensis generally did not. M. rancensis only weakly inhibited one Colletotrichum strain, C. fioriniae (11% reduction in growth). Colletotrichum colonies consistently formed an oval shape in co-cultures with S. symmetrica and Neokomagataea species, whereas growth in the negative control was circular (FIG. 4). And except for some M. rancensis tests, inhibition occurred at distance, with co-culture species not growing in contact with one another.

TABLE 4
Relative growth of fungal pathogens in dual culture plate assays.

| | Relative growth of pathogen with dual culture antagonist | | | |
|---|---|---|---|---|
| Pathogen | Mran | Ntan | Ntha | Symm |
| Cacu1 | 0.93 ± 0.02 | 0.64 ± 0.01 *** | 0.67 ± 0.03 ** | 0.56 ± 0.01 *** |
| Cacu2 | 1.02 ± 0.00 | 0.54 ± 0.01 *** | 0.57 ± 0.02 *** | 0.60 ± 0.01 *** |
| Cacu3 | 1.00 ± 0.01 | 0.54 ± 0.01 *** | 0.57 ± 0.01 *** | 0.62 ± 0.01 *** |
| Cacu4 | 0.94 ± 0.01 ● | 0.57 ± 0.01 *** | 0.62 ± 0.01 *** | 0.69 ± 0.01 *** |
| Cglo | 0.94 ± 0.02 ● | 0.61 ± 0.02 *** | 0.62 ± 0.01 *** | 0.69 ± 0.04 * |
| Cfio | 0.87 ± 0.01 *** | 0.49 ± 0.02 *** | 0.47 ± 0.00 *** | 0.54 ± 0.02 *** |

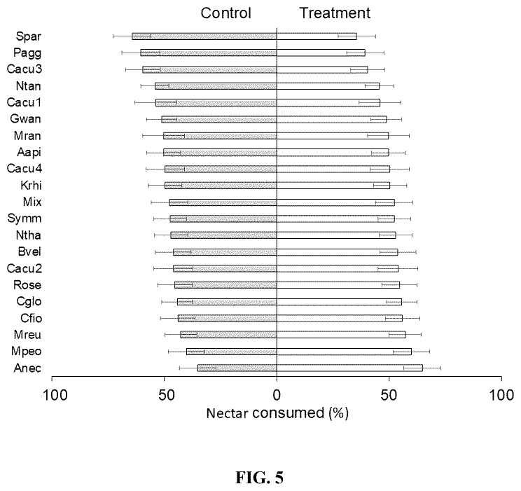

In tests of Colletotrichum and candidate nectar microbes, honey bees did not display feeding preferences between artificial nectars with and without microbes (FIG. 5, p>0.05). On average, bees consumed a total of 57.0±0.97 μL nectar in the 2 h period (mean±se), evenly split between treatments with 27.7±1.13 μL sterile control nectar consumed and 29.4±1.19 μL microbe-inoculated nectar consumed.

Total sugar concentrations in control and inoculated artificial nectar solutions were 214 f 1.8 g L⁻¹ and 212±1.6 g L⁻¹, respectively (mean±se). Sugars, including fructose, glucose, and their sum, were not impacted by any microbial inoculation relative to sterile controls (fructose F_{1,104}=0.23, p=0.63; glucose F_{1,104}=0.75, p=0.39, total sugars F_{1,104}=0.51, p=0.48).

### Example 2

### Field Testing of Anthracnose Prevention

A floral microbial biocontrol consortium was tested in a small-scale field experiment for its ability to prevent anthracnose disease in blueberries. We monitored the microbiome of flowers before and after the biocontrol consortium was applied and found that the biocontrol species rapidly disseminated to non-sprayed flowers, presumably due to vectoring by bees and other flower-visiting insects. To preserve our treatments, we enclosed 1-2 flowering branches per plant with insect exclusion mesh bags. Among berries collected from insect-excluded blooms, a single application of the biocontrol species reduced the number of infected fruits harvested by 46%. Application of biocontrol species did not appear to impair fruit development or reduce individual berry weight. Biocontrol species were not recovered from fruit that were treated with the consortium, indicating that they did not persist from floral tissues to colonize fruit. A screen of nearby honey and bumble bee hives found no viable biocontrol species in nectar and pollen stores. These results suggest that the biocontrol consortium can reduce anthracnose disease in fruit without disrupting fruit development. Furthermore, we show that bees are effective vectors for these species, rapidly disseminating the microbes between blooms.

Biocontrol species (Table 5; *applied to dormant buds, not blooms) were originally isolated from blueberry flowers in Florida and were selected based on their successful inhibition of Colletotrichum spp. growth in laboratory tests. A Colletotrichum acutatum isolate originally collected from infected blueberry fruit grown in Florida was used as the pathogen.

TABLE 5
Biocontrol species isolated from 181 blueberry
nectar samples and detection frequency.

| | | | GenBank | Detection |
|---|---|---|---|---|
| | | | Accession | frequency |
| Kingdom | Species | Abbr. | no. | (%) |
| Fungi | Metschnikowia rancensis | Mran | OP205142 | 12.2 |
| | Symmetrospora | Symm | OP205153 | 19.3 |
| | symmetrica* | | | |
| Bacteria | Neokomagataea tanensis | Ntan | OP595675 | 11.0 |
| | Neokomagataea | Ntha | OP595638 | 24.9 |
| | thailandica | | | |

A field of Southern highbush blueberry plants (Vaccinium corymbosum cv. Farthing) was established in the fall of 2023. 162 one-gallon plants were purchased from a local nursery and planted in nine raised bed rows (ca. 0.3 m high×1 m wide) comprised of pine bark mulch (18 plants per row) and a 5 cm pine straw mulch layer was applied to all rows. Plants were irrigated with drip irrigation once per day for 1 hour. The plants were spaced 1.8 m apart to ensure they would not touch one another upon reaching full size. No pesticides or fertilizers were applied to the plants prior to or during the experiment. A 2.5 m fence was built around the field to protect plants from deer damage. After flowering, netting was draped over the plants to protect the berries from bird damage (Orchard Valley Supply, ¾″ mesh). The field was stocked with two bumble bee hives (Bombus impatiens; Koppert Technologies) prior to flowering. An apiary ca. 96 m away housed 3 active honey bee hives.

Four treatments were adopted: One group was sprayed with the biocontrol mixture and after 24 h, inoculated with the fungal pathogen (“ALL”; n=26 plants). Another group was only sprayed with sterile water before pathogen inoculation (“PTH”; n=26 plants). A third group received the biocontrol spray only and was sham inoculated with sterile water (“MIC”; n=13 plants). The fourth group received only sterile buffer for all sprays and inoculations (control; n=13 plants).

Flowers were sprayed with either the biocontrol consortium (ALL, MIC) or sterile phosphate buffer saline (PBS) buffer (PTH, control) early in the blooming period as soon as most treatment plants had at least 7 open flowers, on the morning of Mar. 4, 2024. Biocontrol consortium sprays were comprised of three species and prepared in PBS: Metschnikowia rancensis (Mran), Neokomagataea tanensis (Ntan), and Neokomagataea thailandica (Ntha).

Mran cells were harvested from three-day old Yeast Mold Agar plates and prepared at 100,000 cells/μL. Ntan and Ntha cells were grown in broth media (160 g/L sucrose, 25 g/L glucose, 3 g/L yeast extract, 5 g/L peptone) and prepared at 0.75 absorbance, respectively, approximately equal to 50-60,000 cells/μL. Spray solutions were placed in spray bottles with nozzles adjusted to emit ca. 3 mL per spray. To spray blooms, branches were gently tipped upwards to allow direct spray to the center aperture of the blueberry blooms. Each cluster of flowers received 2 sprays on average.

Microbial density in the spray solution was optimized in preliminary experiments using a separate set of greenhouse-grown blueberry plants. The selected spray concentrations resulted in 100% successful inoculation of Mran to flowers, defined as delivering a minimum of 1,000 Mran cells/uL to nectar, and 28% and 83% successful inoculations for Ntan and Ntha, respectively, defined as delivering a minimum of 300 cells/uL to nectar.

Prior to spraying flowers with the consortium, all flower buds that were near to, but not yet blooming, were cut from the treatment plants using sterilized scissors to ensure that only flowers that received sprays were included in subsequent tests. Very immature buds which needed >7 days before blooming were left on the plants. Immediately after spraying blooms, 1-2 clusters of flowers on each treatment plant were enclosed in a mesh bag to exclude insects, as we anticipated insects would vector microbes between flowers and could therefore interfere with our treatments. The bagged branches were marked with loops of undyed wool yarn. The number of bagged and unbagged flowers was recorded for each plant. The yeast S. symmetrica was only applied to dormant buds in spray applications performed in December and February, as our preliminary tests revealed application of this yeast to flowers damaged floral tissues and led to rapid senescence.

C. acutatum was prepared from two-week-old Potato Dextrose Agar plates. Spores were harvested from guttation droplets on the plate surface and prepared in a PBS buffer at 10,000 cells/uL. A 20 uL aliquot of this solution was pipetted to each bloom near the anthers/style with an autopipette one day after blooms were sprayed with the consortium. Plants assigned to PTH and ALL treatments were treated with Colletotrichum cells, the flowers of plants assigned to control and MIC treatments were spiked with sterile buffer. A new pipette tip was used for each bloom.

The field was divided into four blocks and plants from all treatments (control, MIC, PTH, ALL) were assigned in each. Each block contained 3-4 control and MIC plants and 6-8 PTH and ALL plants, respectively. Each plant was assigned a unique code which was marked on the field with stake flags near the base of the plant. Plants not involved in a treatment were denoted as buffer plants.

Flowers in the field were monitored for the presence of focal microbes before and after the treatments were applied to plants via plating to selective media and morphological identification. We performed three observations, one before the experiment and two after. Unbagged flowers freely available to insect visitors were cut from plants using sterilized scissors and placed in vials with 1 mL sterile PBS. Samples were then vortexed for 5 min at 2500 rpm. A 20 uL volume of each solution was pipetted to bacteria and fungi-selective plates and incubated at room temperature for 9 days. Presence and absence data as well as percentage plate coverage was then recorded for each plate. Three blueberry flowers per row (27 flowers total) were collected randomly throughout the field the week before treatments. The next collection occurred two days after plants were sprayed with the consortium. One flower was collected from each plant that had unbagged open blooms (n=143). 78 blueberry blooms, one per plant, and wildflowers in the field were collected.

Uncapped honey and pollen stores were collected from 1-2 frames of three honey bee hives each and 4-5 nectar pots and 1 wax sample from two bumble bee hives. Additionally, we collected ripe 26 ripe ALL and 13 ripe MIC berries, surface sterilized them, and macerated in PBS. Bee food and pulverized berry tissue samples were diluted with PBS and plated to selective media to screen for biocontrol species.

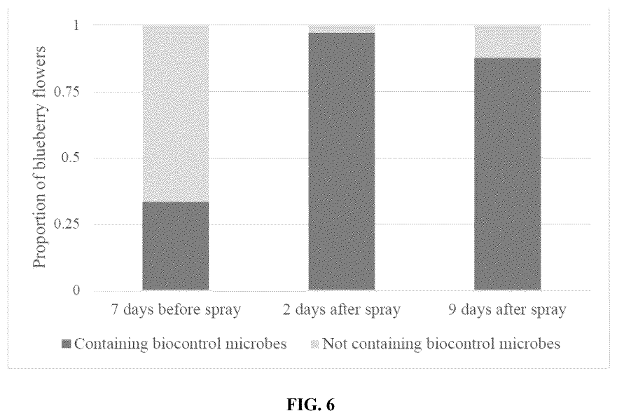

Ripe blueberries were hand harvested from bagged branches. Each fruit weight was recorded, and berries were placed individually into cardboard egg cartons, misted with sterile water and sealed in plastic bags to maintain high humidity. Paper towels were also soaked with sterile water and placed under the egg cartons to increase humidity. Colletotrichum infection in blueberry under high humidity results in characteristic orange droplets that emerge on the fruit surface, allowing positive identification of anthracnose infected fruit (FIG. 6). Harvested berries were monitored 4-5 days per week for symptoms of Colletotrichum or other rot. Rotting berries were discarded after recording symptoms. Observations were terminated 48 days after initial collections began.

All statistical analysis was performed in R. The time for anthracnose infected berries to develop symptoms post-harvest was compared between treatments using a linear model with factors of treatment, berry harvest date, and their interaction. We compared the number of infected berries and individual berry weight between treatments with separate linear mixed models with factors of treatment, harvest date, and random factor of block. Linear models were evaluated using the check_model function in the package performance (easystats.github.io/easystats/) and ANOVAs were conducted to test for significance of factors. When treatment was significant in ANOVAs, we compared differences between treatment groups with estimated marginal means using the emmeans and compared with the contrast function with Tukey method for multiple group comparison correction.

### Results and Discussion

Individual berry weight differed between treatments (F_{3,93}=3.81, p=0.013) and harvest date (F_{1,93}=15.9,p<0.001). Comparing berry weight between treatments, berries collected from the ALL plants weighed more than fruit from PTH plants (p=0.011; Table 6; estimated marginal means and standard errors are reported, and level indicates significant differences between groups). No differences were detected between other treatments.

TABLE 6
Individual berry weights among treatments.

| | Berry Weight | |
|---|---|---|
| Treatment | (mean ± se) | Level |
| ALL | 1.65 ± 0.067 | AB |
| MIC | 1.56 ± 0.078 | BC |
| CTL | 1.43 ± 0.096 | BC |
| PTH | 1.32 ± 0.078 | C |

Although the impact of microbial presence on pollinator affinity remains untested in the field, the berry weight results reported here do still provide encouraging evidence that inoculating flowers with the microbes does not on its own decrease fruit weight, an important metric of fruit quality, or otherwise interfere with fruit development.

The time until anthracnose symptoms were observed for individual berries ranged from 7-43 days, with an average of 21.5 days. Symptom onset was not impacted by the harvest date (F_{1,36}=1.89, p=0.18), microbial treatment (F_{3,36}=0.48, p=0.70) or the interaction of treatment and harvest date (F_{1,36}=3.26, p=0.08).

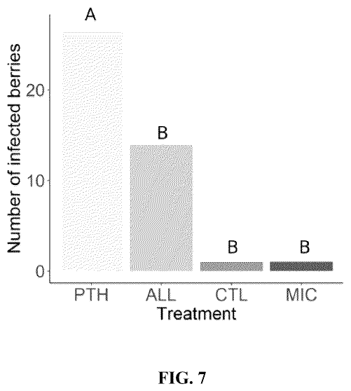

One week prior to biocontrol application, 33% of flowers contained one or more microorganisms with morphology consistent with our biocontrol species. To our knowledge, neither the three-component nor the four-component consortia have been observed to naturally cohabitate within a single flower or nectar drop. (FIG. 7). Two days following the spray, over 97% of flowers contained one or more biocontrol species. This floral survey included both plants that had been directly sprayed with the consortium (ALL, MIC), as well as buffer plants that were not sprayed at all (BUF) and those that were sprayed only with sterile water (PTH, CTL). Of plants that were not directly sprayed with the microbial consortium, over 98% of sampled flowers contained biocontrol species. The following week, nine days after the spray, over 87% of flowers from sprayed and unsprayed plants contained biocontrol cells. We also observed a dramatic increase in cell density of biocontrol species two and nine days after the spray, although populations tended to decrease in flowers over time (data not shown).

We did not detect any biocontrol species in the food stores of bumble or honey bees, or in berry tissues. This was expected, as bees carefully shape the microbiome of their food to prevent spoilage. We also did not anticipate that the consortium members would survive in fruit as floral microbes tend to only be isolated from flowers and not in other plant parts. These findings are encouraging as they suggest that the biocontrol species will not interfere with the hive microbiome or persist in any tissues ingested by humans. We will continue to screen hives and berries to ensure these findings are robust.

Over 480 berries were harvested and monitored for anthracnose symptoms (ALL: 172, CTL: 80, MIC: 77, PTH: 160). The number of anthracnose infected fruit collected from flowers in insect exclusion bags differed between treatments (F_{3,535}=6.67, p<0.001), with 14 collected from the biocontrol sprayed ALL treatment, 26 from the unprotected PTH treatment, and 1 each for MIC and CTL treatments which were not inoculated with Colletotrichum (FIG. 8). The number of infected berries also varied according to harvest date (F_{1,23}=28.7, p<0.001), with fewer infected berries collected at the start and end of harvesting and a peak in the mid-harvest period.

### Example 3

Inhibition of the Plant Pathogen Botrytis cinerea

Botrytis cinerea is a necrotrophic pathogenic fungus that causes the disease commonly known as grey mold in fruits like strawberries, grapes, apples, and blueberries. It can infect blooms, causing blossom blight and flower abortion, thereby reducing crop yields. We evaluated whether the four consortium members could inhibit B. cinerea growth using the previously described dual culture plate assay.

A B. cinerea strain originally isolated from infected blueberry in Florida was cultivated on Potato Dextrose Agar (PDA) plate media for approximately one week. Three-day old cultures of the consortium members (Mran, Symm, Ntha, Ntan) were prepared on PDA plates for yeast and R2A plates for bacteria. No antibiotics were used in the plate media. As described previously, 5 mm plugs were placed in parallel on a PDA plate. A B. cinerea plug was placed in the center and two plugs carrying the same consortium members on either side. Negative controls, where PDA plugs without microbes were placed alongside the pathogen, and positive controls, where 0.5 mg cycloheximide dissolved in 5 μL methanol was spiked to the plate on either side of the pathogen plug, were performed alongside all treatments. Four replicates were prepared for each treatment and control. Plates were incubated on the benchtop at 22-23° C. After approximately one week, the radial growth from the outer edge to the center of the pathogen plug were measured for each side. The two measurements were averaged and recorded as a single replicate. To identify inhibition of pathogens, the mean radial growth was compared between the treatments and negative controls. Each treatment was replicated four times.

Analyses were performed using R Statistical Software (v4.2.2; R Core Team 2022). To assess growth inhibition in the dual culture plate assays, pathogen growth, measured as the distance from outer edge of the pathogen's mycelial growth to the center of the plug, was compared between the control and the microbe test with two-tailed t tests via the t.test function in the stats package.

Of the four consortium members tested, both bacteria (Ntan, Ntha) reduced B. cinerea radial growth by approximately 18% relative to the negative control (Table 7: Bold text indicates significant reduction in growth). Bacterial and pathogen colonies did not grow in contact with one another. Pathogen growth was not affected by coculture with either yeast. Inhibition was also observed in positive controls as anticipated (data not shown).

TABLE 7
Reduction of B. cinerea radial growth
compared to negative control (%).

| | Percent growth | |
|---|---|---|
| | reduction of | |
| | B. cinerea | |
| Microbe | (mean ± se) | p value |
| Mran | 1.6 ± 0.9 | 0.75 |
| Symm | 1.6 ± 1.5 | 0.75 |
| Ntha | 18.6 ± 1.9 | 0.020 |
| Ntan | 17.5 ± 1.4 | 0.027 |

### Example 4

### Pollinator Foraging Assay in a Field Setting.

To evaluate foraging behavior in a more realistic field setting, experiments were conducted at the aforementioned research plot in Gainesville, FL to compare the number of floral visitors (scored as either honey bees, other bees, flies, wasps, butterflies/moths, or other insects) to plants with flowers inoculated with either A) the biocontrol consortium, B) BOTECTOR® (SAN Agrow, Herzogenburg, Austria), a commercially available microbial biocontrol product labeled for use on blueberry plants for control of anthracnose, formulated with two strains of the fungus Aureobasidium pullulans, C) the pathogen C. acutatum, or D) sterile PBS. Flower inoculations were conducted as described above one day before pollinator observations.

Observations were conducted with 32 plants divided into four experimental blocks. Each block was comprised of eight plants with treatments randomly and evenly assigned (n=2 per treatment in each block, n=8 total per treatment; treatments=sterile PBS, C. acutatum, consortium, or BOTECTOR®). Individual plants were enclosed in cages prior to blooming to prevent non-target floral microbes from colonizing flowers via insect vectoring. Cages were briefly opened to treat flowers and removed 15-30 min before the observation periods began. After observation periods ended, cages were replaced.

A single observer conducted observations of a block by recording the number of floral visitors on a plant before moving to the next, monitoring each plant in a circuit every 1-2 min. The number of open flowers per plant was also recorded. Observation periods ranged between 20-37 min and were conducted between 13:00-15:00. The total number of floral visitors in each category was divided by the duration of the observation period to generate a visitation rate (visitor no. per min). Experiments were repeated once per week across four weeks in March 2025. This allowed flowers from the previous week's trial to completely senesce and new, untreated flowers to open. The same three observers conducted observations throughout the experiment and were randomly assigned to blocks. Prior to data collection, observers were trained by inspecting images and videos of frequently observed floral visitors and identifying visitors as a group in the field.

To evaluate differences in floral visitation rates, two response variables were tested in linear mixed-effect models: total visitors per min, which included all insect visitors, and honey bee visits per min, because most floral visitors were honey bees. Fixed effects for these models included treatment, flower number, and their interaction, with random effects of date and start time. Analyses were performed using R Statistical Software (v4.2.2; R Core Team 2022).

Total visitors per min and honey bee visits per min were both significantly affected by the number of flowers on the plant (total: F_{1,192}=168, p<0.0001; honey bees: F_{1,161}=147, p<0.0001), but were not impacted by microbial treatment (total: F_{3,177}=0.83, p=0.5; honey bees: F_{3,148}=0.49, p=0.7) nor the interaction between flower number and treatment (total: F_{3,179}=0.87, p=0.5; honey bees: F_{3,150}=0.70, p=0.6).

These results indicate that blueberry pollinators readily forage from blooms treated with the consortium in a field setting. Therefore, the consortium is likely to exhibit negligible impacts on pollination services and berry yield at scale.

While the invention has been described with reference to details of the illustrated embodiments, these details are not intended to limit the scope of the invention as defined in the appended claims. The embodiment of the invention in which exclusive property or privilege is claimed is defined as follows:

What is claimed is:

1. A microbial consortium composition for controlling a Colletotrichum or Botrytis species, the consortium comprising a carrier and living cells of:
a. Metschnikowia rancensis, Neokomagataea tanensis, and Neokomagataea thailandica, or;
b. Metschnikowia rancensis, Neokomagataea tanensis, Neokomagataea thailandica, and Symmetrospora symmetrica.

2. A method of controlling Colletotrichum or Botrytis species, comprising the step of applying an effective amount of the microbial consortium of claim 1 to a flower, thereby controlling the Colletotricum or Botrytis species.

3. The method of claim 2, wherein the flower is a blueberry flower or a cranberry flower.

4. The method of claim 2, wherein the microbial consortium is applied to the flower by a pollinator.
